(19) United States
(12) Patent Application Publication
(10) Pub. No.: US 2016/0252923 A1
(43) Pub. Date: Sep. 1, 2016

(54) BANDGAP REFERENCE CIRCUIT

(71) Applicant: Elite Semiconductor Memory Technology Inc., Hsinchu (TW)

(72) Inventor: Shu-Han NIEN, Xihu Township (TW)

(73) Assignee: Elite Semiconductor Memory Technology Inc.

(21) Appl. No.: 14/632,035

(22) Filed: Feb. 26, 2015

(51) Int. Cl. G05F 3/26

(52) U.S. Cl. CPC G05F 3/262

(57) ABSTRACT

A bandgap reference circuit incorporates first, second, and third current sources, an operational amplifier coupled to the second and the third current sources, a voltage divider, a first resistor, and first, second, and third bipolar transistors. The second bipolar transistor has a base configured to receive a bias voltage from the voltage divider. The third bipolar transistor has a base and a collector electrically connected to the ground voltage. The first resistor is coupled between the third current source and the third bipolar transistor.

### BACKGROUND OF THE INVENTION

1. Field of the Invention

The present invention relates generally to reference circuits, and more specifically to a bandgap reference circuit.

2. Description of the Related Art

A bandgap reference circuit is used to generate a precise and a stable output voltage. The generated voltage is independent of process, voltage, and temperature. The bandgap reference circuit is widely used in various analogue and digital circuits that require a precise voltage for operation.

FIG. 1 illustrates one commonly used bandgap reference circuit 100. Referring to FIG. 1, the bandgap reference circuit 100 includes PMOS transistors M1, M2, and M3, an operational amplifier OP, resistors R1 and R2, and bipolar transistors Q1, Q2, and Q3. If the base current is neglected, the output voltage VOUT of the bandgap reference circuit 100 can be expressed as:

$$VOUT = VEB 3 + VT \times ln N \times ( \frac{R 2}{R 1} ) \qquad ( 1 )$$

Where VEB3 is the emitter-base voltage of the bipolar transistor Q3, VT is the thermal voltage at room temperature, and N is the ratio of the emitter areas of the bipolar transistor Q2 to the emitter areas of the bipolar transistor Q1.

As can be seen from the equation (1), by adjusting the ratio of resistors R2/R1, the conventional bandgap reference circuit 100 can provide a stable reference voltage VOUT having a zero temperature coefficient. The voltage level of the voltage VOUT is at around 1.25V, which is approximately equal to the silicon energy gap measured in electron volts, i.e., the silicon bandgap voltage.

Referring to FIG. 1, the minimal voltage level of the supply voltage VDD required by the normal operation of the bandgap reference circuit 100 is:

$$VDD = \vert VDS \vert + VEB 3 + VT \times ln N \times ( \frac{R 1}{R 2} ) \qquad ( 2 )$$

Where |VDS| is the drain-source voltage of the PMOS transistor M3.

From equation (2) it can be seen that since the voltage level of VEB3 is around 0.7V, the voltage level of the supply voltage VDD may be larger than 1.8V to maintain the stable reference voltage VOUT.

### SUMMARY OF THE INVENTION

An aspect of the present invention is to provide a bandgap reference circuit.

According to one embodiment of the present invention, the bandgap reference circuit comprises first, second, and third current sources, an operational amplifier, first, second, and third bipolar transistors, a voltage divider, and a first resistor. The operational amplifier is electrically connected to the first, second, and third current sources. The first bipolar transistor has an emitter electrically connected to the first current source, a base and a collector coupled to a ground voltage. The voltage divider is electrically connected between the emitter of the first bipolar transistor, wherein the voltage divider provides a bias voltage proportional to a base-emitter voltage of the first bipolar transistor. The second bipolar transistor has a base configured to receive the bias voltage, an emitter electrically connected to the second current source, and a collector electrically connected to the ground voltage. The third bipolar transistor has a base and a collector electrically connected to the ground voltage. The first resistor is electrically connected between the third current source and an emitter of the third bipolar transistor.

### BRIEF DESCRIPTION OF THE DRAWINGS

The invention will be described according to the appended drawings in which:

FIG. 1 illustrates one commonly used bandgap reference circuit; and

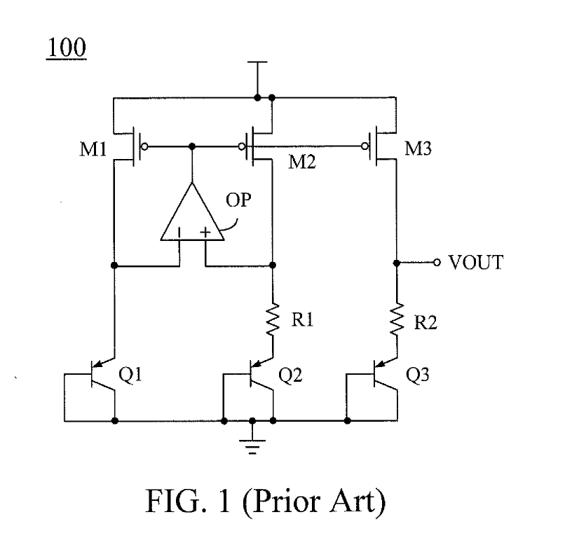

FIG. 2 shows a schematic diagram of a bandgap reference circuit according to one embodiment of the present invention.

### DETAILED DESCRIPTION OF THE INVENTION

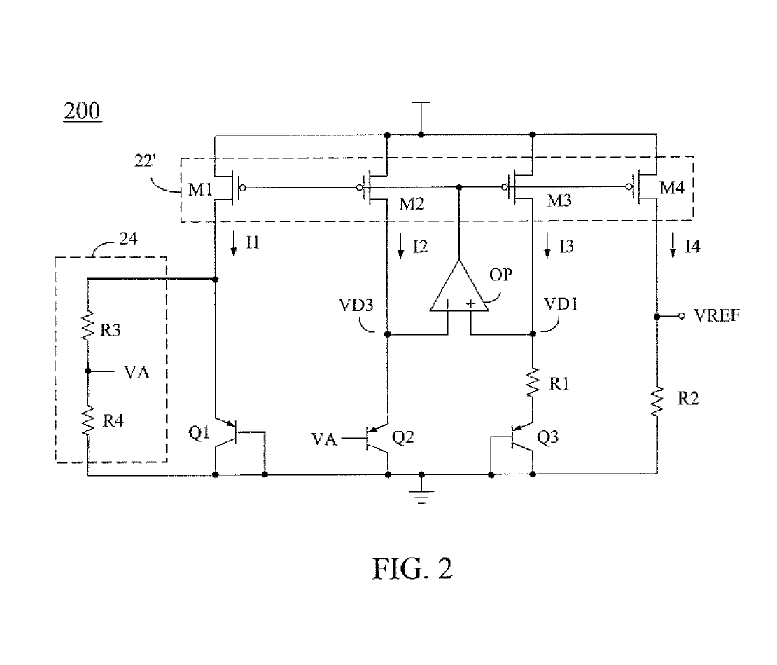

FIG. 2 shows a schematic diagram of a bandgap reference circuit 200 according to one embodiment of the present invention. Referring to FIG. 2, the bandgap reference circuit 200 comprises a current source unit 22, a voltage divider 24, an operational amplifier OP, two resistors R1 and R2, and three bipolar transistors Q1, Q2, and Q3.

The current source unit 22 provides four stable currents I1, I2, I3, and I4. In this embodiment, the current source unit 22 is a current mirror formed by four PMOS transistors M1, M2, M3, and M4. Referring to FIG. 2, each of the PMOS transistors M1, M2, M3, and M4 has a source electrically connected to a supply voltage VDD and has a gate electrically connected to an output terminal of the operational amplifier OP. Since the gates of the PMOS transistors M1, M2, M3, and M4 are connected to each other and the sources of the PMOS transistors M1, M2, M3, and M4 are connected to the common supply voltage VDD, the currents I1, I2, I3, and I4 through the PMOS transistors M1, M2, M3, and M4, respectively, are proportional to the W/L ratio of the transistors.

Referring to FIG. 2, the bipolar transistor Q1 has an emitter coupled to the drain of the PMOS transistor M1 and the voltage divider 24, and has a base and a collector both coupled to a ground voltage. The bipolar transistor Q2 has an emitter coupled to the drain of the PMOS transistor M2, a base coupled to a voltage VA from the voltage divider 24, and a collector coupled to the ground voltage. The bipolar transistor Q3 has a base and a collector both coupled to the ground voltage. The resistor R1 is couple between the drain of the PMOS transistor M3 and an emitter of the bipolar transistor Q3.

Referring to FIG. 2, the operational amplifier OP has a positive input terminal coupled to the drain of the PMOS transistor M3, a negative input terminal coupled to the drain of the PMOS transistor M2, and the output terminal coupled to the gates of the PMOS transistors M1, M2, M3, and M4. The amplifier OP and the PMOS transistors M2 and M3 constitute a negative feedback loop which forces the voltages VD1 and VD3 to be substantially equal. Thus, the voltages VD1 and VD3 can be expressed as:

VD1=VD3=VA+VEB2=VEB3+I3×R1 (3)

VEB2 is the emitter-base voltage of the bipolar transistor Q2, and VEB3 is the emitter-base voltage of the bipolar transistor Q3.

Referring to FIG, 2, the voltage divider 24 is coupled to the emitter of the bipolar transistor Q1. In this embodiment, the voltage divider 24 is formed by two series connected resistors R3 and R4. Therefore, the voltage divider 24 provides the voltage VA proportional to a base-emitter voltage of the bipolar transistor Q1. Thus, the voltage VA can be expressed as:

$$VA = VEB 1 \times \frac{R 4}{R 3 + R 4} \qquad ( 4 )$$

Where VEB1 is the emitter-base voltage of the bipolar transistor Q1.

Accordingly, equation (3) can rearranged into the following equation (5) by using equation (4):

$$\begin{matrix}I 3 \times R 1 = VA + VEB 2 - VEB 3 \\ = VEB 1 \times ( \frac{R 4}{R 3 + R 4} ) + VT \times ln N\end{matrix} \qquad ( 5 )$$

VT is the thermal voltage at room temperature, and N is the ratio of the emitter areas of the bipolar transistor Q3 to the emitter areas of the bipolar transistor Q2. In this embodiment, the currents flowing through the bipolar transistors Q2 and Q3 are substantially equivalent.

Thus, the current I3 through the resistor R1 can be expressed as:

$$I 3 = \frac{1}{R 1} \times ( ( VEB 1 \times ( \frac{R 4}{R 3 + R 4} ) + VT \times ln N ) ) \qquad ( 6 )$$

Since the emitter-base voltage of the transistor Q1 has a negative temperature coefficient of −2 mV/° C. and the thermal voltage VT has a positive temperature coefficient of 0.085 mV/° C., the temperature coefficient of the current I3 can be adjusted to be positive, negative, or substantially zero. The positive temperature coefficient of the current I3 is obtained by increasing the values of N. The negative temperature coefficient of the current I3 is obtained by increasing the ratio of the voltage divider 24. The temperature coefficient of the current I3 can be adjusted to be substantially zero by varying the values of N and the ratio of the voltage divider 24.

In order to provide a stable reference voltage having a low (e.g., substantially zero) temperature coefficient, the bandgap reference circuit 200 comprises the resistor R2 connected between the drain of the PMOS transistor M4 and the ground voltage as shown in FIG. 2. With such a circuit configuration, the reference voltage VREF can be expressed as:

VREF=I4×R2 (7)

In this embodiment, currents flowing through transistors Q1, Q2 and Q3 are the same. In addition, a size ratio of the PMOS transistors M1, M2, M3, and M4 in the current source unit 22 is set to 2:1:1:1. Therefore, the current I2, I3, and I4 are substantially the same and the current I1 has twice the magnitude of the current I2. Since the currents I3 and I4 have the same value, equation (7) can be rearranged into the following equation (8) by using equation (6):

$$VREF = ( \frac{R 2}{R 1} ) \times ( ( VEB 1 \times ( \frac{R 4}{R 3 + R 4} ) + VT \times ln N ) ) \qquad ( 8 )$$

Hence, the positive temperature coefficient of the voltage VREF is obtained by increasing the values of N. The negative temperature coefficient of the voltage VREF is obtained by increasing the ratio of the voltage divider 24. If the value of N, the ratio of the voltage divider 24, and the ratio of the resistance value of resistor R2 to R1 are selected appropriately, the output voltage VREF of the bandgap reference circuit 200 will have a zero temperature coefficient and low sensitivity to temperature.

In addition, compared with the prior art, the bandgap reference circuit 200 of FIG. 2 can be operable at a lower supply voltage level. Recalling equation (1):

$$VOUT = VEB 3 + VT \times ln N \times \frac{R 1}{R 2} \qquad ( 1 )$$

From equation (1) it can be seen that the output voltage of the conventional bandgap reference circuit is limited to 1.25V in order to obtain a zero temperature coefficient. However, from equation (8) it can be seen that the output voltage VREF of the bandgap reference circuit of the invention can be reduced since the resistor R2 is directly connected to the ground voltage, rather than the bipolar transistor. With such circuit configuration, the bandgap reference circuit of the invention can provide an output voltage VREF in a wide voltage range from 0V to 0.64V depending on the value of the resistor R2. Therefore, the bandgap reference circuit 200 can be operated at the lower supply voltage level, e.g., on the order of 1V.

The above-described embodiments of the present invention are intended to be illustrative only. Numerous alternative embodiments may be devised by those skilled in the art without departing from the spirit and scope of the invention as recited in the following claims.

What is claimed is:

1. A bandgap reference circuit, comprising:
first, second, and third current sources;
an operational amplifier electrically connected to the first, second, and third current sources;
a first bipolar transistor having a base, an emitter, and a collector, the emitter electrically connected to the first current source, the base and the collector coupled to a ground voltage;
a voltage divider electrically connected between the emitter of the to first bipolar transistor, wherein the voltage divider provides a bias voltage proportional to a base-emitter voltage of the first bipolar transistor;
a second bipolar transistor having a base, an emitter, and a collector, the base configured to receive the bias voltage, the emitter electrically connected to the second current source, and the collector electrically connected to the ground voltage;
a third bipolar transistor having a base, an emitter, and a collector, the base and the collector electrically connected to the ground voltage; and
a first resistor electrically connected between the third current source and the emitter of the third bipolar transistor.

2. The bandgap reference circuit of claim 1, further comprising:
a fourth current source, electrically connected to the operational amplifier; and
a second resistor electrically connected between the fourth current source and the ground voltage;
wherein an intersection of the fourth current source and the second resistor provides a bandgap reference voltage.

3. The bandgap reference circuit of claim 2, wherein the first current source is composed of a PMOS transistor having a source electrically connected to a supply voltage, a gate electrically connected to an output terminal of the operational amplifier, and a drain electrically connected to the emitter of the first bipolar transistor.

4. The bandgap reference circuit of claim 3, wherein the second current source is composed of a PMOS transistor having a source electrically connected to the supply voltage, a gate electrically connected to the output terminal of the operational amplifier, and a drain electrically connected to the emitter of the second bipolar transistor and a first input terminal of the operational amplifier.

5. The bandgap reference circuit of claim 4, wherein the third current source is composed of a PMOS transistor having a source electrically connected to the supply voltage, a gate electrically connected to the output terminal of the operational amplifier, and a drain electrically connected to the first resistor and a second input terminal of the operational amplifier.

6. The bandgap reference circuit of claim 5, wherein the fourth current source is composed of a PMOS transistor having a source electrically connected to the supply voltage, a gate electrically connected to the output terminal of the operational amplifier, and a drain electrically connected to the second resistor.

7. The bandgap reference circuit of claim 1, wherein the voltage divider comprises:
a plurality of resistors serially electrically connected between the emitter and the base of the first bipolar transistor for providing the bias voltage.

8. The bandgap reference circuit of claim 1, wherein the positive temperature coefficient of current through each of the first, second, and third current sources is obtained by increasing a ratio of the emitter areas of the third bipolar transistor to the emitter areas of the second bipolar transistor.

9. The bandgap reference circuit of claim 1, wherein the negative temperature coefficient of current through each of the first, second, and third current sources is obtained by increasing a ratio of the voltage divider.

10. The bandgap reference circuit of claim 1, wherein the positive temperature coefficient of the bandgap reference voltage is obtained by increasing a ratio of the emitter areas of the third bipolar transistor to the emitter areas of the second bipolar transistor,

11. The bandgap reference circuit of claim 1, wherein the negative temperature coefficient of the bandgap reference voltage is obtained by increasing a ratio of the voltage divider.

12. The bandgap reference circuit of claim 2, wherein the bandgap reference voltage is less than about 0.64V.

13. The bandgap reference circuit of claim 2, wherein the supply voltage of the bandgap reference voltage is less than about 1V.
